(19) United States
(12) Patent Application Publication
(10) Pub. No.: US 2025/0110602 A1
(43) Pub. Date: Apr. 3, 2025

(54) INTERFACE OPERATION METHOD AND APPARATUS, ELECTRONIC DEVICE, AND STORAGE MEDIUM

(71) Applicant: GUANGDONG OPPO MOBILE TELECOMMUNICATIONS CORP., LTD., Dongguan (CN)

(72) Inventors: Boyu MO, Dongguan (CN); Jiabai WEI, Dongguan (CN)

(73) Assignee: GUANGDONG OPPO MOBILE TELECOMMUNICATIONS CORP., LTD., Dongguan (CN)

(21) Appl. No.: 18/981,098

(22) Filed: Dec. 13, 2024

Related U.S. Application Data
(63) Continuation of application No. PCT/CN2022/143820, filed on Dec. 30, 2022.

(30) Foreign Application Priority Data
Jun. 14, 2022 (CN) 202210672883.5

(51) Int. Cl. G06F 3/0481; G06F 3/0484

(52) U.S. Cl. CPC G06F 3/0481; G06F 3/0484; G06F 2203/04803

(57) ABSTRACT

An interface operation method and an apparatus, an electronic device, and a storage medium. The method is applied to an electronic device and includes: displaying a plurality of application interfaces in a split-screen manner; and switching at least two of the plurality of application interfaces to a floating-window display state in response to a first operation acted on a screen of the electronic device.

### CROSS-REFERENCE TO RELATED APPLICATIONS

The present application is a continuation-application of International (PCT) Patent Application No. PCT/CN2022/143820, filed on Dec. 30, 2022, which claims priority of Chinese Patent Application No. 202210672883.5, filed on Jun. 14, 2022, the entire contents of which are hereby incorporated by reference in their entireties.

### TECHNICAL FIELD

The present disclosure relates to the technical field of terminals, and in particular to an interface operation method and an apparatus, an electronic device, and a storage medium.

### BACKGROUND

With the development of terminal technology, electronic devices can display multiple application interfaces in a split-screen manner. However, in the case of electronic devices displaying multiple application interfaces in a split-screen manner, and the multiple application interfaces include two or more interfaces, when the user desires to start other application interfaces, he/she needs to close the application interfaces displayed on the multiple application interfaces based on the split screen, which in turn causes the electronic device to be unable to display the real-time status of the closed application interfaces.

### SUMMARY OF THE DISCLOSURE

In view of the above problems, the present disclosure proposes an interface operation method, apparatus, electronic device, and storage medium.

In a first aspect, the present disclosure provides an interface operation method, applied to an electronic device and including: displaying a plurality of application interfaces in a split-screen manner; and switching at least two of the plurality of application interfaces to a floating-window display state in response to a first operation acted on a screen of the electronic device.

In a second aspect, the present disclosure provides an interface operation apparatus, performed by an electronic device and including: an interface display unit, configured to display a plurality of application interfaces in a split-screen manner; and an interface operation unit, configured to switch at least two of the plurality of application interfaces to a floating-window display state in response to a first operation acted on a screen of the electronic device.

In a third aspect, the present disclosure provides an electronic device, including one or more processors and a memory; where one or more programs are stored in the memory and configured to be executed by the one or more processors, the one or more programs being configured to perform the method as above.

In a fourth aspect, the present disclosure provides a computer-readable storage medium, storing program code executable by a processor; where the computer-readable storage medium stores program code, and the program code is configured to perform the method as above.

### BRIEF DESCRIPTION OF THE DRAWINGS

In order to more clearly illustrate the technical solution in the embodiments of the present disclosure, the following is a brief description of the drawings needed to be used in the description of the embodiments. Obviously, the drawings described below are only some embodiments of the present disclosure. For those skilled in the art, without the expenditure of creative labor, other drawings can be obtained based on these drawings.

FIG. 1 is a schematic diagram of an application scenario for an interface operation method according to some embodiments of the present disclosure.

FIG. 2 is a schematic diagram of another application scenario for an interface operation method according to some embodiments of the present disclosure.

FIG. 3 is a flowchart of an interface operation method according to some embodiments of the present disclosure.

FIG. 4 is a schematic diagram of multiple application interfaces being displayed in a split-screen manner according to some embodiments of the present disclosure.

FIG. 5 is a schematic diagram of an application interface being cut and displayed in a floating manner according to some embodiments of the present disclosure.

FIG. 6 is a schematic diagram of three application interfaces being displayed in a split-screen manner according to some embodiments of the present disclosure.

FIG. 7 is a schematic diagram of path positions of a first operation according to some embodiments of the present disclosure.

FIG. 8 is schematic diagram of application interfaces displayed in a split-screen manner, which shrink the display area in response to a first operation according to some embodiments of the present disclosure.

FIG. 9 is a flowchart of an interface operation method according to other embodiments of the present disclosure.

FIG. 10 is a technical schematic diagram for displaying at least two application interfaces in a floating manner according to some embodiments of the present disclosure.

FIG. 11 is a schematic diagram of an application interface displayed in a floating manner being operated to increase the display area according to some embodiments of the present disclosure.

FIG. 12 is a schematic diagram of an application interface displayed in a floating manner whose display area is enlarged according to some embodiments of the present disclosure.

FIG. 13 is a flowchart of an interface operation method according to other embodiments of the present disclosure.

FIG. 14 is a schematic diagram of a third operation according to some embodiments of the present disclosure.

FIG. 15 is a schematic diagram of a split-screen waiting state according to some embodiments of the present disclosure.

FIG. 16 is a schematic diagram of an arrangement of multiple application interfaces in a split-screen display state according to some embodiments of the present disclosure.

FIG. 17 is a block diagram of a video playback apparatus according to some embodiments of the present disclosure.

FIG. 18 is a block diagram of an electronic device for implementing an interface operation method according to some embodiments of the present disclosure.

FIG. 19 is a storage unit for storing or carrying program code that implements an interface operation method according to some embodiments of the present disclosure.

### DETAILED DESCRIPTION

The following description of the technical solutions in the embodiments of the present disclosure will be provided in a clear and complete manner with reference to the accompanying drawings in the embodiments of the present disclosure. Obviously, the embodiments described are only some embodiments of the present disclosure, but not all of the embodiments. Based on the embodiments in the present disclosure, all other embodiments obtained by those skilled in the art without creative effort fall within the scope of the present disclosure.

With the development of terminal technology, more and more applications are installed in electronic devices, and more and more functions can be realized by these applications. In some cases, users expect to be able to use multiple applications at the same time, and can operate the electronic device to trigger the interfaces of these multiple applications to be displayed in a split-screen manner. In a case where the interfaces of multiple applications are displayed in a split-screen manner, the multiple application interfaces belonging to different applications can be displayed simultaneously on the screen of the electronic device.

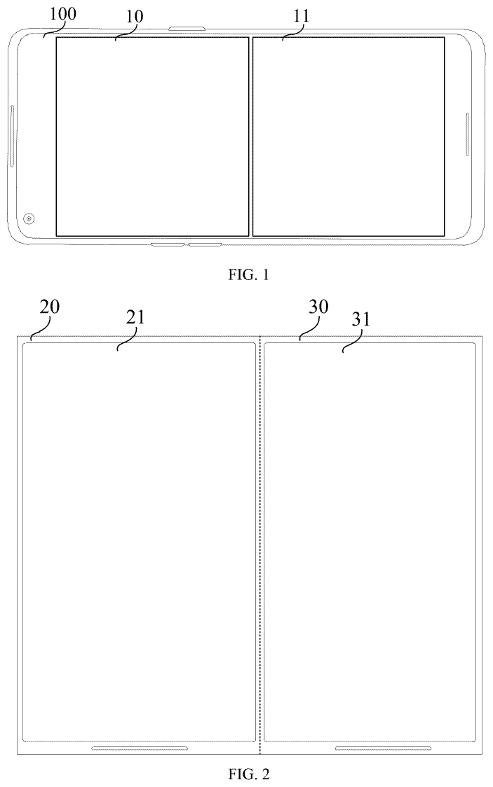

For example, as shown in FIG. 1, an application interface 10 and an application interface 11 are displayed in a split-screen manner. In a case shown in FIG. 1, the application interfaces 10 and 11 displayed in a split-screen manner are displayed in different regions of the screen of the electronic device 100. For another example, as shown in FIG. 2, the electronic device may include a display region 20 and a display region 30 (which are divided by a dotted line), and the display region 20 and the display region 30 can be folded relative to each other. When the display region 20 and the display region 30 are folded to a state shown in FIG. 2, the display region 20 and the display region 30 can be in the same plane, in which case an application interface 21 can be displayed in the display region 20 and an application interface 31 can be displayed in the display region 30, that is, the application interfaces 21 and 31 are in a split-screen display state.

However, the inventor discovered during research that, in cases of displaying application interfaces in a split-screen manner in the related art, if the user needs to start other application interfaces (interfaces other than the application interfaces displayed in a split-screen manner), he/she needs to close the application interfaces of the multiple applications displayed in a split-screen manner, which in turn causes the electronic device to be unable to display the real-time status of the closed application interfaces.

Therefore, the inventor proposes an interface operation method, apparatus, electronic device and storage medium in the present application. When displaying multiple application interfaces in a split-screen manner, and the multiple application interfaces include two or more interfaces, at least two of the multiple application interfaces can be switched to a floating-window display state in response to a first operation acted on the screen. Therefore, in the above manner, when there are multiple application interfaces displayed in a split-screen manner, at least two of the multiple application interfaces can be switched to a floating-window display state by triggering the first operation, such that the at least two application interfaces can be floated over the newly opened application interface. In this way, the electronic device can still display the real-time status of the at least two application interfaces in real time while displaying the newly opened interface.

In the embodiments of the present disclosure, the interface operation method can be applied to the scenarios shown in FIGS. 1 and 2.

The following will specifically describe the embodiments of the present disclosure in conjunction with the accompanying drawings.

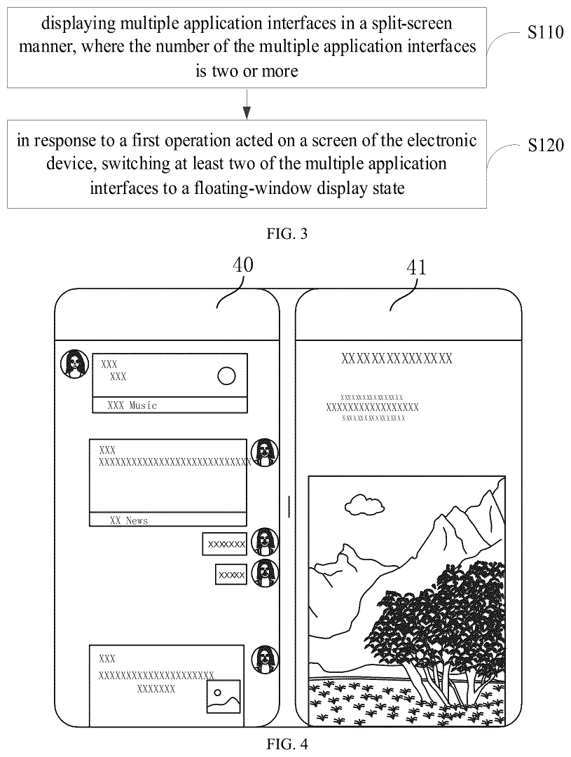

Referring to FIG. 3, the present disclosure provides an interface operation method, applied to an electronic device and including operations at blocks illustrated herein.

At block S110: displaying multiple application interfaces in a split-screen manner, where the number of the multiple application interfaces is two or more.

In the embodiments of the present disclosure, the multiple application interfaces are displayed in a split-screen manner, which may be understood to mean that the multiple application interfaces are displayed together in a screen of the electronic device, and that the display regions occupied by the multiple application interfaces are different. For example, referring again to FIGS. 1 and 2, the multiple application interfaces displayed in a split-screen manner are arranged side by side on the screen. Furthermore, in the embodiments of the present disclosure, the number of the multiple application interfaces displayed in a split-screen manner is not specifically limited, and the number of such multiple application interfaces may be at least two. For example, as shown in FIGS. 1 and 2, there may be two application interfaces displayed in a split-screen manner, or there may be three or more application interfaces displayed in a split-screen manner.

At block S120: in response to a first operation acted on a screen of the electronic device, switching at least two of the multiple application interfaces to a floating-window display state.

The first operation is an operation that triggers the switching of at least two of the multiple application interfaces to a floating-window display state. The switching of at least two of the multiple application interfaces to the floating-window display state allows the electronic device to directly display another application interface below the application interfaces in the floating-window display state. That is, this display mode can display interfaces other than the multiple application interfaces. For example, when at least two of the application interfaces are switched to the floating-window display state, and the electronic device further opens another application interface, the opened other application interface can be displayed directly cascaded below the at least two application interfaces, or it may be understood that the at least two application interfaces in the floating-window display state can be directly floated above the other application interface further opened by the electronic device. In this way, when the electronic device opens another application interface, the user can still directly see the real-time status of the application interfaces originally displayed in a split-screen manner.

The real-time status of the application interface may include real-time changes in the content displayed on the application interface. For example, when the application interface is a chat interface, the content displayed on the chat interface is chat content, and the real-time changes in the chat interface are the real-time changes in the chat content. Another example is when the application interface is a video interface, the content displayed on the video interface is video content, and the real-time changes in the video interface are the changes in the video content.

In the embodiments of the present disclosure, the first operation for triggering the switching of at least two of the application interfaces to the floating-window display state may be implemented in various ways. For example, the first operation may be a swiping operation, a tapping operation, a long-pressing operation, etc. In the embodiments of the present disclosure, there are various ways to set which operation is the first operation. As one way, the first operation may be preconfigured by the developer. As another way, the first operation may be configured by the user of the electronic device according to his/her own operating habits. In this way, the electronic device may be configured with a setting interface for the first operation, in which the user can set the specific operation mode of the first operation according to his/her need.

In the embodiments of the present disclosure, during the process of switching at least two application interfaces among the multiple application interfaces to the floating-window display state, the number of the at least two application interfaces specifically switched to the floating-window display state may be determined according to the actual situation. For example, when there are only two application interfaces displayed in a split-screen manner, the switching at least two application interfaces to the floating-window display state means switching all the application interfaces displayed in the split-screen manner to the floating-window display state. When there are three or more application interfaces displayed in a split-screen manner, the switching at least two application interfaces to the floating-window display state means selecting at least two application interfaces from the multiple application interfaces displayed in the split-screen manner to the floating-window display state.

In the embodiments, there are various ways to determine which of the multiple application interfaces displayed in the split-screen manner will be switched to the floating-window display state.

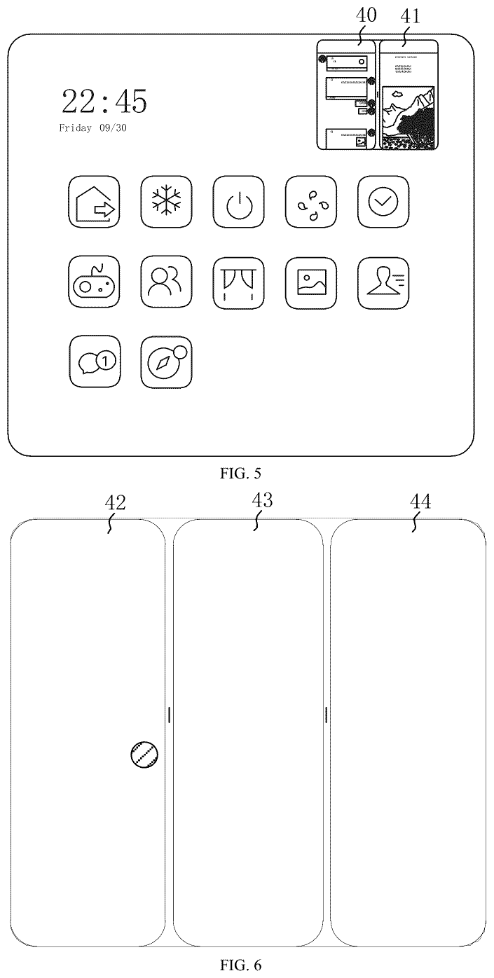

As one way, when the number of the multiple application interfaces displayed in the split-screen manner is two, the electronic device, in response to the first operation, switches both the application interfaces displayed in the split-screen manner to the floating-window display state. For example, as shown in FIG. 4, an application interface 40 and an application interface 41 are displayed in a split-screen manner on the screen of the electronic device. After the first operation is acted on the screen, as shown in FIG. 5, the application interface 40 and the application interface 41 are displayed in a floating manner on the screen. In the case shown in FIG. 5, the application interface 40 and the application interface 41 are displayed in a floating manner on the desktop interface.

When the number of the multiple application interfaces displayed in the split-screen manner is three or more, the electronic device may determine the application interfaces to be switched to the floating-window display state based on a default configuration. For example, the electronic device may select and switch two application interfaces arranged on a left side of the screen by default to the floating-window display state, or the electronic device may select and switch two application interfaces arranged on a right side of the screen by default to the floating-window display state. Furthermore, alternatively, the electronic device may determine the application interfaces to be switched to the floating-window display state based on the first operation.

In a case of determining the application interfaces to be switched to the floating-window display state based on the first operation, the application interfaces to be switched to the floating-window display state may be determined based on a position on which the first operation is acted. In some embodiments, when the distance between a corresponding position of an application interface and the position on which the first operation is acted is less than a specified distance threshold, the application interface is determined to be switched to the floating-window display state. The corresponding position of the application interface may be the center position in the application interface. For example, as shown in FIG. 6, application interfaces 42, 43 and 44 are displayed in a split-screen manner on the screen of the electronic device. In a case shown in FIG. 6, when the first operation is acted on the illustrated circular region, and it is determined that the application interfaces, of which the spacing between the corresponding position and the circular region is less than the specified distance threshold, include the application interfaces 42 and 43, the application interfaces 42 and 43 will be switched to the floating-window display state.

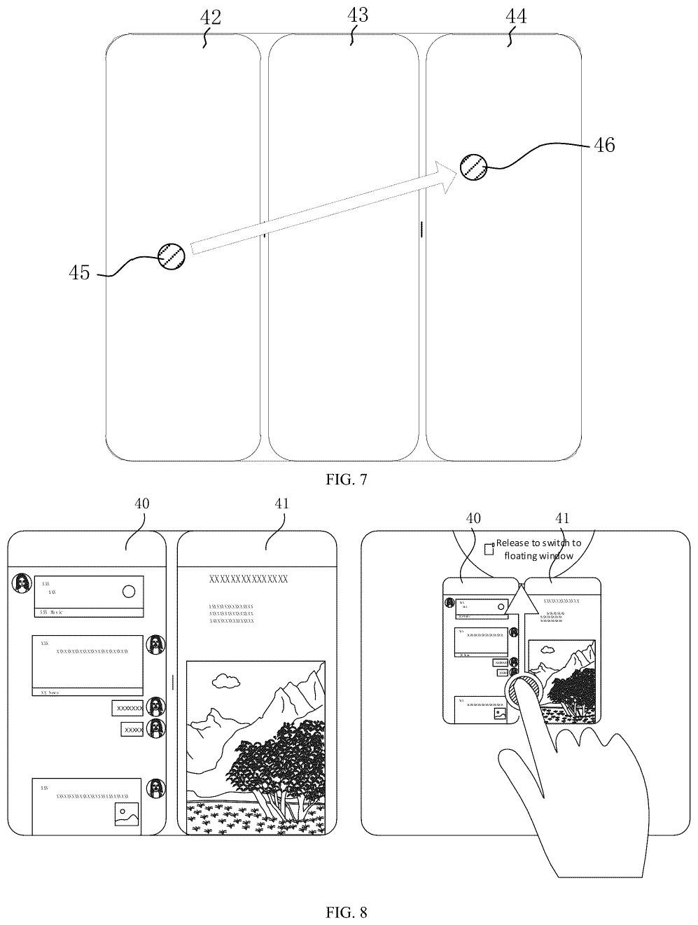

In some embodiments, among the multiple application interfaces displayed in a split-screen manner, the application interface that has contact with the first operation may be switched to the floating-window display state. For example, the first operation may be a swiping operation, in which case, when a swiping operation is detected, positions traversed by the swiping operation are recorded, and the region occupied by each application interface is compared with the positions traversed by the swiping operation. When the region occupied by the application interface is overlapped with the positions traversed by the swiping operation, the application interface is determined to be switched to the floating-window display state. For example, as shown in FIG. 7, the application interfaces 42, 43, and 44 are displayed in the screen of the electronic device in a split-screen manner; where the circular region 45 is a start position of the swiping operation, and the circular region 46 is an end position of the swiping operation; and the swiping operation is triggered from the circular region 45 in the direction indicated by the dashed arrow and ends at the circular region 46. As can be seen in FIG. 7, the positions traversed by the swiping operation are overlapped with the regions occupied by application interfaces 42, 43, and 44, and thus, the electronic device will take the application interfaces 42, 43, and 44 as application interfaces that are required to be switched to the floating-window display state.

As another way, in a case of the first operation being a multi-finger touch gesture, the application interface acted by the first operation can be determined as the application interface to be switched to the floating-window display state. When the first operation is a multi-finger touch gesture, the application interface acted by the first operation may be understood to be an application interface that is touched. For example, in the case of the multi-finger touch gesture being a two-finger swiping operation, when the electronic device detects a two-finger swiping operation, the application interface that is touched can be determined as the application interface that is required to be switched to the floating-window display state.

It should be noted that, in some embodiments of the present disclosure, after determining the application interfaces required to be switched to the floating-window display state, a floating window may be configured for each application interface, such that each application interface can be displayed in a corresponding floating window, thereby achieving the switching of the application interface to the floating-window display state.

In some embodiments of the present disclosure, in order to further enhance the user experience, for the application interfaces that are determined to switch from the split-screen display state to the floating-window display state, a process animation may be correspondingly configured between the two states. For example, the first operation may be a swiping operation starting from a specified position. The electronic device may trigger at least two of the multiple application interfaces to reduce the display areas in response to the swiping operation starting from the specified position, and switch the at least two application interfaces to the floating-window display state in response to a touch object that acts the swiping operation ending touching the screen. In some embodiments, after the swiping operation starting from the specified position is triggered, at least two of the multiple application interfaces may be made to gradually reduce their display areas as the swiping operation progresses. In some embodiments, after the swiping operation starting from the specified position is triggered, at least two of the multiple application interfaces may be made to directly reduce their display areas to a predetermined size. For example, as shown in FIG. 8, when the user swipes from the bottom of the screen (a designated position) to a designated height through a finger (a touch object), the display area of the application interface that is required to be switched to the floating-window display state may be triggered to shrink (reducing from the display area shown in the image on the left to the display area shown in the image on the right), and after the touch object (e.g., finger) that acts the swiping operation ends contact with the screen, the application interfaces 40 and 41 are triggered to be switched to the floating-window display state shown in FIG. 5.

Furthermore, in the embodiments of the present disclosure, the electronic device may restore the multiple application interfaces to be displayed in a split-screen manner in response to a second operation on the application interfaces that are in the floating-window display state. The second operation is an operation that triggers the restoration of the original split-screen display state of the application interface that was switched to the floating-window display state due to the first operation. In the embodiments of the present application, the second operation may be implemented in various ways. For example, the second operation may include an operation to increase the size of the application interface. In this case, in response to an operation acted on the application interface in the floating-window display state to increase the size of the application interface, the size of the application interface in the floating-window display state is increased, and when the size of the application interface in the floating-window display state is greater than a size threshold, the multiple application interfaces are restored to be displayed in a split-screen manner. The operation to increase the size of the application interface may include an operation to press an edge of the application interface and then drag the application interface while pressing the edge of the application interface. Further, the second operation may be a click operation on the application interface, a long press operation on the application interface, etc. In the embodiments of the present disclosure, there are various ways to set which operation is the second operation. As one way, the second operation may be preconfigured by the developer. As another way, the second operation may be configured by the user of the electronic device according to his/her own operating habits. In this way, the electronic device may be configured with a setting interface for the second operation, and in the setting interface for the second operation, the user may set the specific operation mode for the second operation.

It should be noted that in the embodiments of the present disclosure, in a case where both the first operation and the second operation can be configured by the user, the first operation and the second operation are different operations, such that the electronic device can distinguish the purpose of the user's current operation.

The above embodiments provide an interface operation method in which, when multiple application interfaces are displayed in a split-screen manner and the multiple application interfaces include two or more interfaces, at least two of the multiple application interfaces can be switched to be displayed in a floating-window display state in response to a first operation acted on the screen. Therefore, when there are multiple application interfaces displayed in a split-screen manner, at least two of the multiple application interfaces can be switched to a floating-window display state by triggering the first operation, such that the at least two application interfaces can be floated on top of the newly opened application interface, such that the electronic device can still display the real-time status of the at least two application interfaces in real time while displaying the newly opened interface.

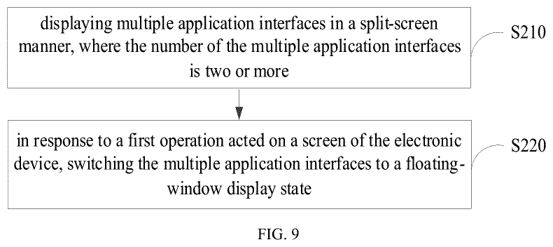

Referring to FIG. 9, the present disclosure provides an interface operation method, applied to an electronic device and including operations at blocks illustrated herein.

At block S210: displaying multiple application interfaces in a split-screen manner, where the number of the multiple application interfaces is two or more.

At block S220: in response to a first operation acted on a screen of the electronic device, switching the multiple application interfaces to a floating-window display state.

As one way, the displaying multiple application interfaces in a split-screen manner, where the number of the multiple application interfaces is two or more, includes: displaying the multiple application interfaces in a split-screen manner, and configuring the multiple application interfaces in a first display container. In this case, the in response to a first operation acted on a screen of the electronic device, switching the multiple application interfaces to a floating-window display state includes: in response to the first operation acted on the screen, switching a display mode of the first display container to a floating-window mode, for switching all the multiple application interfaces to the floating-window display state.

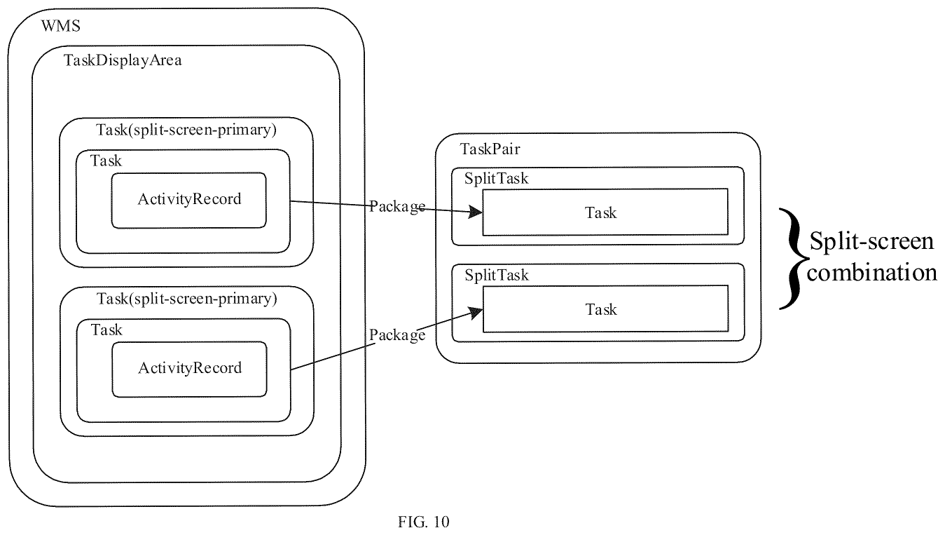

It should be noted that in the embodiments of the present disclosure, the operating system of the electronic device is Android as an example. The electronic device may generate the first display container based on TaskPair class (which inherits the native Task object). Each of the multiple application interfaces displayed in a split-screen manner corresponds to an Activity component. In the embodiments of the present disclosure, the multiple application interfaces displayed in a split-screen manner are configured in the first display container, as shown in FIG. 10. This may be understood as saving the Tasks corresponding to the multiple application interfaces each having an Activity component to the TaskPair class. Then, the SurfaceControl of the Task corresponding to each of the multiple application interfaces displayed in a split-screen manner is re-mounted (reparent) to the SurfaceControl of the TaskPair class, such that the electronic device can directly change the parameters of the SurfaceControl of the TaskPair class to switch at least two of the multiple application interfaces displayed in a split-screen manner to the floating-window display state. For example, the electronic device may switch the display mode of the first display container to the floating-window mode (for example, set the WindowMode of the TaskPair class to the floating-window mode) in order to switch multiple application interfaces to the floating-window display state.

It should be noted that when at least two application interfaces are switched to floating-window display state, the display area of the at least two application interfaces may be reduced. This reduction may be understood as a reduction relative to the original split-screen display. Then, when the application interface to be switched to the floating-window display state is displayed in the first display container generated based on the TaskPair class, the display area of the at least two application interfaces may be reduced by reducing the bound region of the Task corresponding to the application interface to be switched to the floating-window display state.

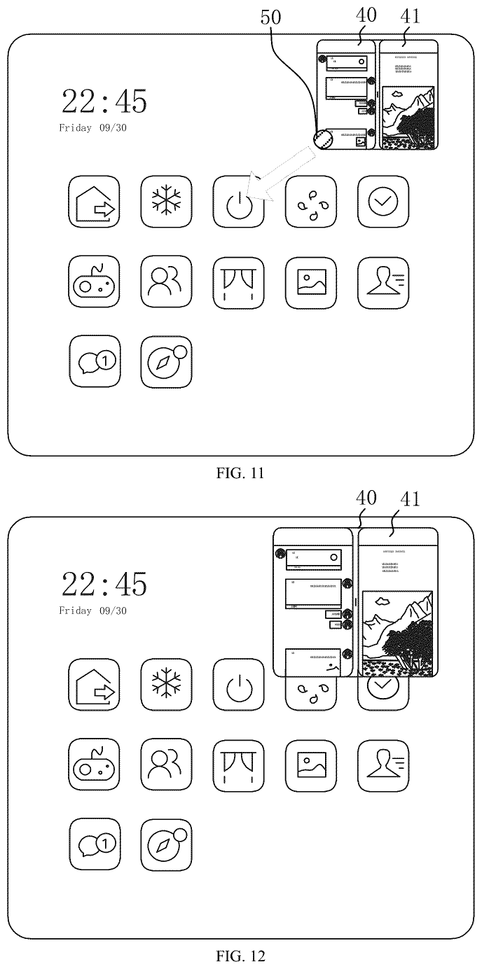

Alternatively, the in response to a first operation acted on a screen of the electronic device, switching the multiple application interfaces to a floating-window display state includes: in response to the first operation acted on the screen, obtaining a floating window corresponding to each of the multiple application interfaces, such that the multiple application interfaces are displayed in the corresponding floating windows. It should be noted that when the multiple application interfaces are displayed in a split-screen manner, the multiple application interfaces may be understood as a split-screen combination. That is, the multiple application interfaces are displayed based on a combination method. In a case where the multiple application interfaces are displayed in their corresponding the floating windows, the multiple the floating-window display state may be understood as a floating-window combination. In some embodiments, the floating windows corresponding to the multiple application interfaces are in a combined relationship. The method provided by the embodiments of the present disclosure further includes: in response to a touch operation acted on any of the floating windows, obtaining a control operation corresponding to the touch operation, and performing the control operation on the floating windows corresponding to the multiple application interfaces. For example, as shown in FIG. 11, when a drag-and-drop operation with a starting position as the circular region 50 is conducted, it can be determined that the drag-and-drop operation is acted on the floating window corresponding to the application interface 40, and the control operation on the floating window is to increase the display area of the floating window in which the application interface 40 is located to simultaneously increase the display area of application interface 40. In this case, the electronic device also simultaneously increases the display area of the floating window in which application interface 41 is located to simultaneously increase the display area of application interface 41, such that application interfaces 40 and 41 can be simultaneously increased to the manner shown in FIG. 12.

It should be noted that in the embodiments of the present disclosure, the at least two application interfaces, among the multiple application interfaces displayed in a split-screen manner, that are switched to the floating-window display state may be associated with each other in the floating-window display state. The application interfaces associated with each other can be transformed synchronously in terms of display position and display area. For example, in a case where the display area of an application interface displayed in the floating-window display state is increased or decreased in response to a user operation, the display area of other application interfaces associated with the user-operated application interface will be increased or decreased synchronously. For another example, when the display position of an application interface in the floating-window display state is moved in response to a user operation, other application interfaces associated with the user-operated application interface will move simultaneously. In some embodiments, after determining the application interfaces that are required to be switched to the floating-window display state, corresponding floating-windows may be configured for the application interfaces to establish the association between the multiple application interfaces in the floating-window display state.

In addition, in the embodiments of the present disclosure, when at least two application interfaces are switched to the floating-window display state, the at least two application interfaces may be floated at a certain distance apart or floated side by side. When they are floated at a certain distance apart, the interval between the floating application interfaces will be greater, and will be greater than the interval between multiple application interfaces floated side by side, such that the user can visually distinguish the application interfaces floated at intervals from the application interfaces floated side by side.

In some embodiments of the present disclosure, the electronic device may determine the specific floating method of at least two application interfaces switched to the floating-window display state in a variety of ways.

As one way, the specific display method of application interfaces switched to the floating-window display state may be configured by the user. For example, the user can configure the at least two application interfaces switched to the floating-window display state to be floated at a certain distance from each other, or the user can configure the at least two application interfaces switched to the floating-window display state to be floated side by side.

Alternatively, the electronic device may determine the specific floating-window display state method based on a degree of content correlation between at least two application interfaces that are switched to the floating-window display state. It should be noted that, for some applications, users may use them together during use. For example, when watching a travel video, some users also like to open a map application at the same time, such that when they hear the name of a place in the travel video, they can directly view the geographical location of the place in the map application. Another example is that some users like to open an information recording application simultaneously when using a conference program, such that they can record the information in the conference through the information recording application.

Then, in a case where these applications that will be used together are displayed in a split-screen manner, when the application interfaces of at least two of these applications are switched to the floating-window display state, the application interfaces of the at least two applications may be configured to be floated side by side, such that the user can conveniently operate the application interfaces. The electronic device may store a correspondence table of applications that can be run together. In this case, in response to the first operation, the electronic device may first detect whether a correspondence exist among the applications of which the application interfaces are determined to be in the floating-window display state. When there is a correspondence, the application interfaces determined to be in the floating-window display state are configured to be displayed in a floating manner side by side. When there is no correspondence, the application interfaces determined to be in the floating-window display state are configured to be displayed in a floating manner at a certain distance apart.

For example, the correspondence includes: a correspondence between application A and application B, a correspondence between application C and application D, and a correspondence between application E and application F. In this case, when, in response to the first operation, it is first detected that the applications of which the application interfaces are determined to be in the floating-window display state include application A and application C, then it is determined that no correspondence exists between the applications of which the application interfaces are determined to be in the floating-window display state, and the application interfaces determined to be in the floating-window display state are configured to be displayed in a floating manner at a certain distance apart. When, in response to the first operation, it is first detected that the applications of which the application interfaces are determined to be in the floating-window display state include application C and application D, then it is determined that a correspondence exists between the applications of which the application interfaces are determined to be in the floating-window display state, and the application interfaces determined to be in the floating-window display state are configured to be displayed in a floating manner side by side.

In the embodiments, when it is determined that the application interfaces are configured to be displayed in a floating manner side by side, the electronic device may further determine a floating position based on the position on which the first operation is acted. In this case, the position where the first operation ends may be determined as the position where the application interface is floated.

The above embodiments provide an interface operation method in which, when multiple application interfaces are displayed in a split-screen manner, at least two of the multiple application interfaces can be switched to a floating-window display state by triggering the first operation. In this way, the at least two application interfaces can be floated on top of the newly opened application interface, such that the electronic device can still display the real-time status of the at least two application interfaces in real time while displaying the newly opened interface. Furthermore, in the embodiments, multiple application interfaces that are displayed in full screen can be switched to the floating-window display state, such that after the electronic device opens a new application interface, the real-time status of multiple application interfaces that were originally displayed in a split-screen manner can be more comprehensively displayed.

Referring to FIG. 13, the present disclosure provides an interface operation method, applied to an electronic device and including operations at blocks illustrated herein.

At block S310: displaying multiple application interfaces in a split-screen manner, where the number of the multiple application interfaces is two or more.

At block S320: in response to a first operation acted on a screen of the electronic device, switching at least two of the multiple application interfaces to a floating-window display state.

At block S330: in response to a third operation acted on the screen, determining an interface acted upon by the third operation from the multiple application interfaces as a target interface.

It should be noted that, in a case where multiple application interfaces are displayed in a split-screen manner, in addition to the first operation for switching at least two application interfaces to the floating-window display state, the third operation may further be conducted to trigger one of the multiple application interfaces to switch to the floating-window display state. The application interface determined in response to the third operation to be switched to the floating-window display state is the target interface.

At block S340: switching the target interface to the floating-window display state, and switching interfaces of the multiple application interfaces other than the target interface to a split-screen waiting state.

The target interface is an interface in the multiple application interfaces on which the third operation is acted.

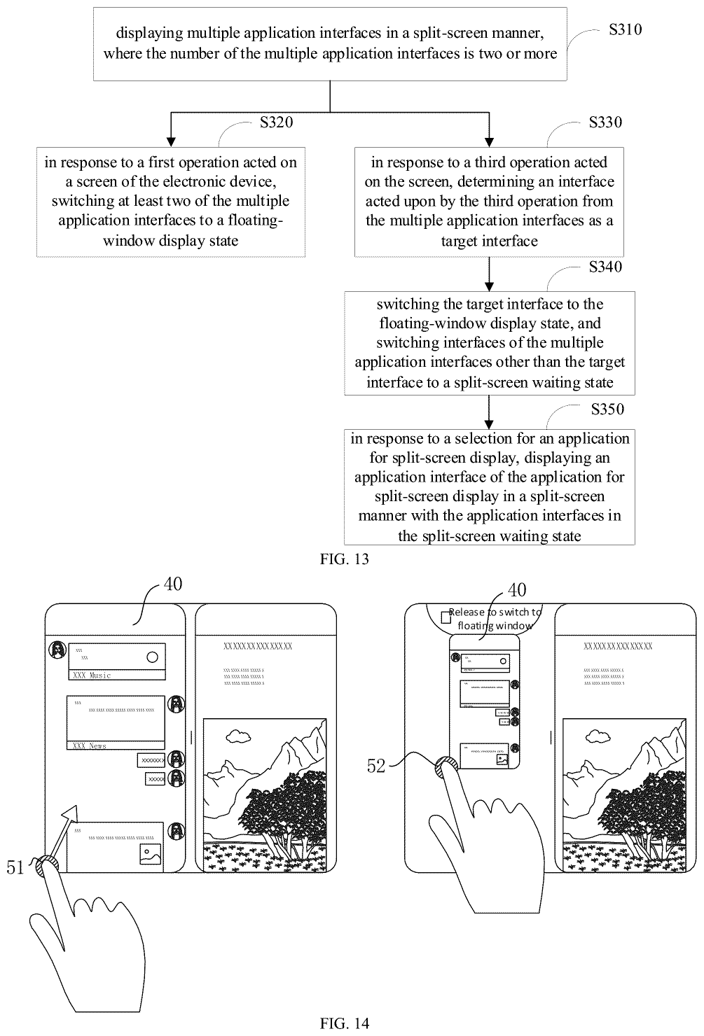

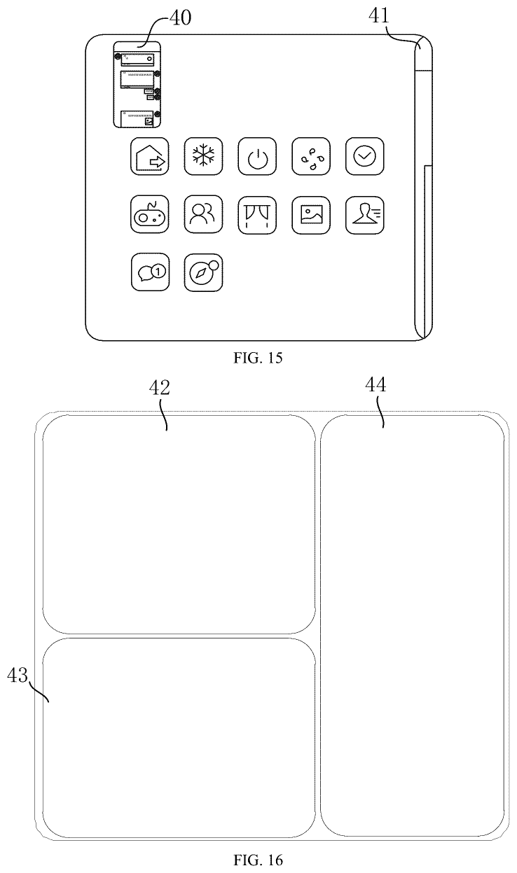

In the embodiments of the present disclosure, the split-screen waiting state characterizes a state in which the user is waiting for further selection of an application to trigger the application to be displayed in a split-screen manner. Correspondingly, the application interface in the split-screen waiting state will be displayed in split-screen with the application interface of an application further selected by the user. In some embodiments, when an application interface is in the split-screen waiting state, a part of the display region will be hidden to reduce the occupation of the screen and facilitate the user to further select the application to be displayed in a split-screen manner. For example, the third operation may be a swiping operation starting from a corner of the screen, as shown in FIG. 14. Therefore, when a swiping operation starting from the corner 51 of the screen is conducted and the swiping operation continues until the specified position 52, the application interface 40 acted by the third operation is taken as the target interface and its the display area is reduced. After the user's finger ends the touch with the screen, the application interface 40 can be switched to the floating-window display state as shown in FIG. 15, and the application interface 41 can be switched to the split-screen waiting state.

At block S350: in response to a selection for an application for split-screen display, displaying an application interface of the application for split-screen display in a split-screen manner with the application interfaces in the split-screen waiting state.

As one way, after the displaying an application interface of the application for split-screen display in a split-screen manner with the application interfaces in the split-screen waiting state, the application interface switched to the floating-window display state may further be configured to be floated above the application interfaces previously in the split-screen waiting state. It is understood that in the S350, the user selects the application for split-screen display as the application that the user is currently more concerned about. In order to avoid causing interference to the content displayed in the application that the user is currently more concerned about by the application interface that was previously switched to the floating-window display state, the application interface that was switched to the floating-window display state may be floated above the application interface that was previously in the split-screen waiting state. For example, in the electronic device, when an application interface M and an application interface N are displayed in a split-screen manner, and the electronic device switches the application interface M to the floating-window display state in response to the third operation, the application interface N will be in the split-screen waiting state. Subsequently, when the user selects an application L for split-screen display, the application interface of the application L and the application interface N will be displayed in a split-screen manner, in which case the application interface M in the floating-window display state will be floated above application interface N.

In addition, after the application interface of the application for split-screen display is displayed in a split-screen manner with the application interfaces in the split-screen waiting state, the application interface displayed in a floating manner (in the floating-window display state) may be configured to return to the previous split-screen display state by triggering a fourth operation on the application interface in the floating-window display state.

In the embodiments of the present disclosure, the fourth operation may be implemented in various ways. For example, the fourth operation may be a swiping operation, a tapping operation, a long-pressing operation, etc. In the embodiments of the present disclosure, there are various ways to configure which operation is the fourth operation. As one way, the fourth operation may be preconfigured by the developer. As another way, the fourth operation may be configured by the user of the electronic device according to his/her own operating habits. In this way, the electronic device may be configured with a setting interface for the fourth operation, and in the setting interface for the fourth operation, the user can set the specific operation method for the fourth operation.

It should be noted that in the embodiments of the present disclosure, both the third operation and the fourth operation may be configured by the user. The third operation and the fourth operation shall be different operations, such that the electronic device can distinguish the purpose of the user's current operation.

The above embodiments provide an interface operation method in which, when multiple application interfaces are displayed in a split-screen manner, at least two of the multiple application interfaces can be switched to a floating-window display state by triggering the first operation. In this way, the at least two application interfaces can be floated on top of the newly opened application interface, such that the electronic device can still display the real-time status of the at least two application interfaces in real time while displaying the newly opened interface. Furthermore, in the embodiments, the electronic device can further respond to a third operation, such that only the target interface among the multiple application interfaces displayed in a split-screen manner is floated, and another application interface among the multiple application interfaces is switched to the split-screen waiting state. In this way, the user can more conveniently switch between the application interfaces displayed in a split-screen manner, and at the same time, can simultaneously see the real-time status of the application interface that was displayed in a split-screen manner (the application interface currently switched to the floating-window display state).

It should be noted that when an application interface is in the floating-window display state, a flipping operation from the user is required to display a part of content of the application interface. Usually, the user triggers the flipping of the application interface by swiping the application interface. However, when the application interface is in the floating-window display state mode, triggering a swiping operation on the application interface may further drag the application interface to change the display position of the application interface.

In this case, in order to avoid mis-operation of the electronic device, an operation related to the interface content may be forbidden for the application interface that is switched from the split-screen display state to the floating-window display state. When the user wishes to perform the content-related operation on the application interface switched to the floating-window display state, he/she may trigger an operation to switch back the floating-window display state to a split-screen display state or a full-screen display state, and then perform the content-related operation on the application interface. The operation related to the interface content includes flipping through the application interface, clicking on the content (text or image) in the application interface, changing the content in the application interface, and inputting content in the application interface.

Alternatively, it may be determined whether a specified action is triggered before detecting a swiping operation on the application interface in the floating-window display state. When the specified action is triggered, it is determined that the effect of the swiping operation on the application interface is to flip the application interface; and when no specified action is triggered, it is determined that the effect of the swiping operation on the application interface is to drag the application interface.

Furthermore, it should be noted that when the electronic device displays multiple application interfaces in a split-screen manner, the arrangement of the multiple application interfaces may be in various ways. For example, the arrangement of the application interfaces 42, 43 and 44 may be as shown in FIG. 16, or as shown in FIGS. 6 and 7 above. In a case where it is determined that the multiple application interfaces displayed in a split-screen manner are all switched to the floating-window display state, the arrangement of the multiple application interfaces in the floating-window display state may be the same as the previous arrangement in a split-screen manner.

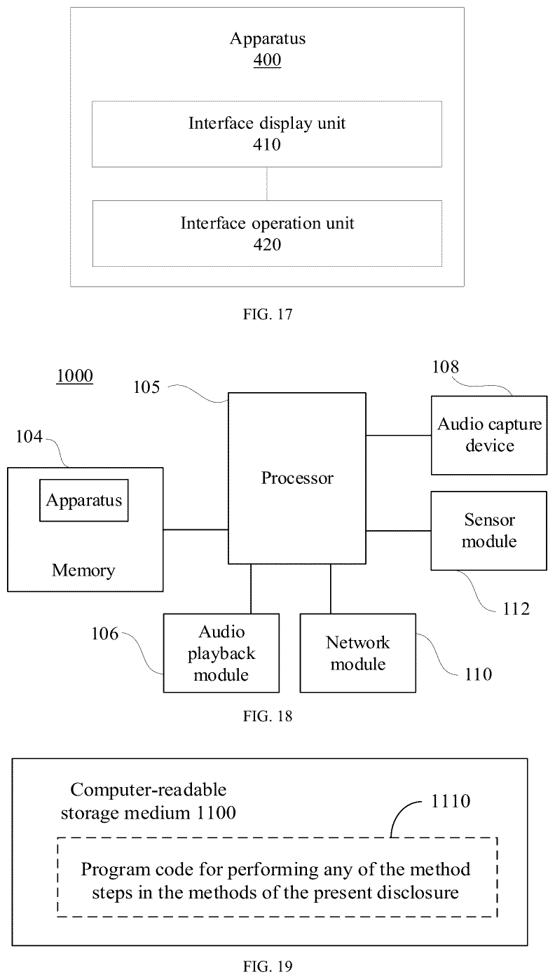

Referring to FIG. 17, the present disclosure provides an interface operation apparatus 400 performed by an electronic device, including:
an interface display unit 410, configured to display multiple application interfaces in a split-screen manner, where the number of the multiple application interfaces is two or more; and
an interface operation unit 420, configured to switch at least two of the multiple application interfaces to a floating-window display state, in response to a first operation acted on a screen of the electronic device.

In some embodiments, the interface operation unit 420 is specifically configured to switch all the multiple application interfaces to the floating-window display state in response to the first operation acted on the screen.

In some embodiments, the interface display unit 410 is specifically configured to display the multiple application interfaces in a split-screen manner and to arrange the multiple application interfaces in a first display container. Correspondingly, the interface operation unit 420 is specifically configured to switch a display mode of the first display container to a floating-window mode in response to the first operation acted on the screen, so as to switch the multiple application interfaces to the floating-window display state. In some embodiments, the interface operation unit 420 is specifically configured to obtain, in response to the first operation acted on the screen, a floating window corresponding to each of the multiple application interfaces; and cause the multiple application interfaces to be displayed in the floating windows corresponding to the multiple application interfaces. In some embodiments, the floating windows corresponding to the multiple application interfaces are in a combined relationship. In this case, the interface operating unit 420 is further configured to, in response to a touch operation acted on any of the floating windows, obtain a control operation corresponding to the touch operation, and perform the control operation on the floating windows corresponding to the multiple application interfaces.

In some embodiments, the interface operation unit 420 is specifically configured to trigger a reduction in the display area of at least two of the multiple application interfaces in response to a swiping operation that starts from a specified position; and to switch the at least two application interfaces to the floating-window display state in response to a touch object that acts the swiping operation ending touching the screen.

In some embodiments, the interface operation unit 420 is further configured to restore the multiple application interfaces to be displayed in a split-screen manner in response to a second operation on the application interfaces that are in the floating-window display state.

In some embodiments, the interface operating unit 420 is further configured to determine, in response to a third operation acted on the screen, an interface acted upon by the third operation from the multiple application interfaces as a target interface; switch the target interface to the floating-window display state, and switch another application interface of the multiple application interfaces other than the target interface to a split-screen waiting state. In this case, the interface operation unit 420 is further configured to, in response to a selection for an application for split-screen display, display an application interface of the application for split-screen display in a split-screen manner with the application interface in the split-screen waiting state.

The above embodiments provide an interface operating apparatus that. When displaying multiple application interfaces in a split-screen manner, and the multiple application interfaces include two or more interfaces, at least two of the multiple application interfaces can be switched to a floating-window display state in response to a first operation acted on the screen. Therefore, in the above manner, when there are multiple application interfaces displayed in a split-screen manner, at least two of the multiple application interfaces can be switched to a floating-window display state by triggering the first operation, such that the at least two application interfaces can be floated over the newly opened application interface. In this way, the electronic device can still display the real-time status of the at least two application interfaces in real time while displaying the newly opened interface.

It should be noted that the apparatus embodiments in the present disclosure and the foregoing method embodiments correspond to each other, and the specific implementation principles of each unit in the apparatus embodiments are similar to those in the foregoing method embodiments. The specific content of the apparatus embodiments can be found in the method embodiments and will not be repeated here.

The following will explain an electronic device provided in the present disclosure in conjunction with FIG. 18.

Referring to FIG. 18, based on the above-described interface operation method and apparatus, the present disclosure further provides an electronic device 1000 that can execute the aforementioned interface operation method. The electronic device 1000 includes one or more (only one is shown) processors 105, a memory 104, an audio playback module 106, and an audio capture device 108 that are coupled to each other. The memory 104 stores a program that can execute the contents of the foregoing embodiments, and the processor 105 can execute the program stored in the memory 104.

The processor 105 may include one or more processing cores. The processor 105 connects various parts of the entire electronic device 1000 using various interfaces and lines, and executes various functions of the electronic device 1000 and processes data, by running or executing instructions, programs, code sets, or instruction sets stored in the memory 104 and calling data stored in the memory 104. In some embodiments, the processor 105 may be implemented in at least one of the hardware forms of digital signal processing (DSP), field-programmable gate array (FPGA), and programmable logic array (PLA). The processor 105 may integrate one or a combination of a central processing unit (CPU), a graphics processing unit (GPU), and a modem. The CPU is mainly configured to handle the operating system, user interface, and applications. The GPU is configured to render and draw display content. The modem is configured to handle wireless communication. It is understood that the modem may alternatively be implemented separately from the processor 105 by a communication chip.

The memory 104 may include random access memory (RAM) and may further include read-only memory (ROM). The memory 104 may be configured to store instructions, programs, code, code sets, or sets of instructions. For example, the memory 104 may store a content display apparatus. The content display apparatus may be the aforementioned apparatus 400. The memory 104 may include a program storage region and a data storage region, where the program storage region may store instructions for implementing the operating system, instructions for implementing at least one function (e.g., touch function, sound playback function, image playback function, etc.), instructions for implementing each of the method embodiments, etc.

Furthermore, the electronic device 1000 may include, in addition to the aforementioned elements, a network module 110 and a sensor module 112.

The network module 110 is configured to enable information interaction between the electronic device 1000 and other devices. For example, a connection can be established with other audio playback devices or other electronic devices, and information interaction can be performed based on the established connection. In some embodiments, the network module 110 of the electronic device 1000 is an RF module, which is configured to receive and transmit electromagnetic waves, and to convert the electromagnetic waves to electrical signals and vice versa, so as to communicate with communication networks or other devices. The RF module may include various existing circuit components for performing these functions, such as an antenna, an RF transceiver, a digital signal processor, an encryption/decryption chip, a subscriber identity module (SIM) card, a memory, etc. For example, the RF module may interact with external devices via the transmitted or received electromagnetic waves.

The sensor module 112 may include at least one sensor. Specifically, the sensor module 112 may include, but is not limited to, a pressure sensor, a motion sensor, an acceleration sensor, and other sensors.

In particular, the pressure sensor may be a sensor that detects pressure generated by pressing on the electronic device 1000. That is, the pressure sensor detects pressure generated by contact or pressing between the user and the electronic device 1000, for example, pressure generated by contact or pressing between the user's ear and the electronic device 1000. Thus, the pressure sensor may be configured to determine whether contact or pressing has occurred between the user and the electronic device 1000, as well as the magnitude of the pressure.

The acceleration sensor can detect the magnitude of acceleration in various directions (generally three axes). W when stationary, the acceleration sensor can detect the magnitude and direction of gravity. The acceleration sensor can be applied in applications that identify the attitude of the electronic device 1000 (such as landscape and portrait screen switching, related games, and magnetometer attitude calibration), and vibration recognition related functions (such as pedometers, knocks), etc. In addition, the electronic device 1000 may further be configured with other sensors such as gyroscopes, barometers, hygrometers, thermometers, etc., which will not be described in detail here.

The audio capture device 108 is configured to acquire audio signals. In some embodiments, the audio capture device 108 includes multiple audio acquisition elements, which may be microphones.

Referring to FIG. 19, FIG. 19 is a block diagram of a computer-readable storage medium according to some embodiments of the present disclosure. The computer-readable medium 1100 stores program code, which can be called by a processor to execute the method described in the above method embodiments.

The computer-readable storage medium 1100 may be an electronic memory such as flash memory, electrically erasable programmable read-only memory (EEPROM), EPROM, hard disk, or ROM. In some embodiments, the computer-readable storage medium 1100 includes a non-transitory computer-readable storage medium. The computer-readable storage medium 1100 has storage space for program code 1110 for performing any of the method steps in the methods described above. The program code can be read from or written to one or more computer program products. The program code 1110 may be compressed, for example, in an appropriate form.

In the description of this specification, references to the terms “an embodiment,” “some embodiments,” “an example,” “specific examples,” or “some examples” are intended to mean that the specific features, structures, materials, or characteristics described in conjunction with the embodiment or example are included in at least one embodiment or example of the present disclosure. In this specification, the illustrative expressions of the above terms do not necessarily refer to the same embodiment or example. Moreover, the specific features, structures, materials, or characteristics described may be combined in any suitable manner in one or more embodiments or examples. Furthermore, in the absence of any conflict, those skilled in the art may combine and/or group the different embodiments or examples described in this specification and the features of different embodiments or examples.

In addition, the terms “first” and “second” are intended for descriptive purposes only and are not to be construed as indicating or implying relative importance or as implying that the technical features indicated are in any particular number. Thus, features defined with “first” and “second” can expressly or impliedly include at least one of the features. In the description of the present disclosure, the meaning of “multiple” is at least two, for example, two, three, etc., unless otherwise expressly and specifically limited.

Any process or method description depicted in a flowchart or otherwise described herein is understood to represent a module, fragment or portion of code including executable instructions for implementing one or more steps for achieving a particular logical function or process. The scope of the embodiments of the present disclosure includes alternative implementations, which may perform the functions in a different order than that shown or discussed, including performing the functions in substantially parallel or in reverse order based on the functions involved, which should be understood by those skilled in the art.

The logic and/or steps represented in a flowchart or otherwise described herein may be, for example, considered to be a sequence listing of executable instructions for implementing the logic functions, which may be implemented in any of computer-readable media for use by or in conjunction with an instruction execution system, device or apparatus (e.g., a computer-based system, a system including a processor or other system that can retrieve instructions from an instruction execution system, device or apparatus and execute the instructions).

It should be understood that portions of the present disclosure may be implemented in hardware, software, firmware, or a combination thereof. In the above-described embodiments, various steps or methods may be implemented using software or firmware stored in memory and executed by a suitable instruction execution system. For example, when implemented in hardware, as in other embodiments, the various steps or methods can be implemented using any one or a combination of the following techniques that are well known in the art: discrete logic circuits with logic gates for performing logical functions on data signals, application-specific integrated circuits with suitable combinations of logic gates, programmable gate arrays (PGAs), field-programmable gate arrays (FPGAs), etc.

In summary, the present disclosure provides an interface operation method, apparatus, electronic device, and storage medium. When displaying multiple application interfaces in a split-screen manner, and the multiple application interfaces include two or more interfaces, at least two of the multiple application interfaces can be switched to a floating-window display state in response to a first operation acted on the screen. Therefore, in the above manner, when there are multiple application interfaces displayed in a split-screen manner, at least two of the multiple application interfaces can be switched to a floating-window display state by triggering the first operation, such that the at least two application interfaces can be floated over the newly opened application interface. In this way, the electronic device can still display the real-time status of the at least two application interfaces in real time while displaying the newly opened interface.

Finally, it should be noted that the above embodiments are provided for the purpose of illustrating, rather than limiting, the technical solutions of the present disclosure. Although the present disclosure has been described in detail with reference to the foregoing embodiments, those skilled in the art will understand that the technical solutions described in the foregoing embodiments can be modified, or some of the technical feature drawings can be replaced by equivalent ones; and these modifications or replacements do not drive the essence of the corresponding technical solutions out of the spirit and scope of the technical solutions in the embodiments of the present disclosure.

What is claimed is:

1. An interface operation method, applied to an electronic device and comprising:
displaying a plurality of application interfaces in a split-screen manner; and
switching at least two of the plurality of application interfaces to a floating-window display state in response to a first operation acted on a screen of the electronic device.

2. The method according to claim 1, wherein the switching at least two of the plurality of application interfaces to a floating-window display state in response to a first operation acted on a screen of the electronic device comprises:
switching all the plurality of application interfaces to the floating-window display state in response to the first operation acted on the screen.

3. The method according to claim 2, wherein the displaying a plurality of application interfaces in a split-screen manner comprises:
displaying the plurality of application interfaces in the split-screen manner and arranging the plurality of application interfaces in a first display container;
wherein the switching all the plurality of application interfaces to the floating-window display state in response to the first operation acted on the screen comprises: switching a display mode of the first display container to a floating-window mode in response to the first operation acted on the screen, so as to switch the plurality of application interfaces to the floating-window display state.

4. The method according to claim 2, wherein the switching all the plurality of application interfaces to the floating-window display state in response to the first operation acted on the screen comprises:
obtaining a floating window corresponding to each of the plurality of application interfaces in response to the first operation acted on the screen; and
displaying the plurality of application interfaces in the floating windows corresponding to the plurality of application interfaces.

5. The method according to claim 4, wherein the floating windows corresponding to the plurality of application interfaces are in a combined relationship, and the method further comprises:
in response to a touch operation acted on any of the floating windows, obtaining a control operation corresponding to the touch operation; and
performing the control operation on the floating windows corresponding to the plurality of application interfaces.

6. The method according to claim 1, wherein the at least two of the plurality of application interfaces switched to the floating-window display state are in a floating-window combination.

7. The method according to claim 1, wherein the first operation comprises a swiping operation starting from a specified position, and the switching at least two of the plurality of application interfaces to a floating-window display state in response to a first operation acted on a screen of the electronic device comprises:
triggering a reduction in a display area of each of at least two of the plurality of application interfaces in response to the swiping operation; and
switching the at least two application interfaces to the floating-window display state in response to a touch object that acts the swiping operation ending touching the screen.

8. The method according to claim 1, after the switching at least two of the plurality of application interfaces to a floating-window display state in response to a first operation acted on a screen of the electronic device, comprising:
restoring the plurality of application interfaces to be displayed in the split-screen manner in response to a second operation acted on the at least two of the plurality of application interfaces that are in the floating-window display state.

9. The method according to claim 8, wherein the second operation comprises an operation to increase a size of any of the at least two of the plurality of application interfaces; the restoring the plurality of application interfaces to be displayed in the split-screen manner in response to a second operation acted on the at least two of the plurality of application interfaces that are in the floating-window display state comprises:
in response to the operation acted on any of the at least two of the plurality of application interfaces in the floating-window display state to increase the size of the one of the at least two of the plurality of application interfaces, increasing the size of the one of the at least two of the plurality of application interfaces; and
in response to the size of the one of the at least two of the plurality of application interfaces being greater than a size threshold, restoring the plurality of application interfaces to be displayed in the split-screen manner.

10. The method according to claim 1, further comprising:
in response to a third operation acted on the screen, switching a target interface to the floating-window display state, and switching another application interface of the plurality of application interfaces other than the target interface to a split-screen waiting state; wherein an application interface acted upon by the third operation from the plurality of application interfaces is the target interface.

11. The method according to claim 10, after the switching a target interface to the floating-window display state, and switching another application interface of the plurality of application interfaces other than the target interface to a split-screen waiting state, comprising:
in response to a selection for an application for split-screen display, displaying an application interface of the application for split-screen display in a split-screen manner with the application interface in the split-screen waiting state.

12. The method according to claim 10, wherein the third operation is a swiping operation starting from a specified position.

13. The method according to claim 1, wherein the switching at least two of the plurality of application interfaces to a floating-window display state in response to a first operation acted on a screen of the electronic device comprises:
in a case where a number of the plurality of application interfaces displayed in the split-screen manner is three or more, in response to the first operation acted on the screen, switching the at least two of the plurality of application interfaces to the floating-window display state based on a default configuration.

14. The method according to claim 13, wherein the switching the at least two of the plurality of application interfaces to the floating-window display state based on a default configuration comprises:
for each of the plurality of application interfaces, determining the application interface, of which a spacing between a corresponding position of the application interface and a position on which the first operation is acted is less than a specified distance threshold, as one of the at least two of the plurality of application interfaces to be switched to the floating-window display state.

15. The method according to claim 13, wherein the switching the at least two of the plurality of application interfaces to the floating-window display state based on a default configuration comprises:
for each of the plurality of application interfaces, determining the application interface in contact with the first operation as one of the at least two of the plurality of application interfaces to be switched to the floating-window display state.

16. The method according to claim 1, further comprising:
determining a floating display mode based on a degree of content correlation between the at least two of the plurality of application interfaces switched to the floating-window display state among the plurality of application interfaces displayed in the split-screen manner.

17. The method according to claim 16, wherein the determining a floating display mode based on a degree of content correlation between the at least two of the plurality of application interfaces switched to the floating-window display state among the plurality of application interfaces displayed in the split-screen manner comprises:
for two application interfaces of the at least two of the plurality of application interfaces that are determined to be in the floating-window display state:
detecting whether a correspondence exist among applications corresponding to the two application interfaces;
in response to the correspondence existing, displaying the two application interfaces in a floating manner side by side; and
in response to no correspondence existing, displaying the two application interfaces in a floating manner at a distance apart.

18. The method according to claim 17, wherein the displaying the two application interfaces in a floating manner side by side comprises:
determining a floating position based on a position on which the first operation is acted.

19. An electronic device, comprising one or more processors and a memory;
wherein one or more programs are stored in the memory and configured to be executed by the one or more processors, the one or more programs being configured to perform:
displaying a plurality of application interfaces in a split-screen manner; and
switching at least two of the plurality of application interfaces to a floating-window display state in response to a first operation acted on a screen of the electronic device.

20. A computer-readable storage medium for an electronic device, storing program code executable by a processor of the electronic device; wherein the computer-readable storage medium stores program code, and the program code, when executed, is configured to perform:
displaying a plurality of application interfaces in a split-screen manner; and
switching at least two of the plurality of application interfaces to a floating-window display state in response to a first operation acted on a screen of the electronic device.
